(19) United States
(12) Patent Application Publication
(10) Pub. No.: US 2012/0199506 A1
(43) Pub. Date: Aug. 9, 2012

(54) APPARATUS AND METHOD FOR PROTECTING MOUNTED ALMEN STRIPS

(76) Inventors: Thomas A. Beach, West Hartford, CT (US); Walter A. Beach, West Suffield, CT (US)

(21) Appl. No.: 13/365,896

(22) Filed: Feb. 3, 2012

Related U.S. Application Data
(60) Provisional application No. 61/462,461, filed on Feb. 3, 2011.

(51) Int. Cl. B65D 85/00; B23P 11/00

(52) U.S. Cl. 206/305; 29/428

(57) ABSTRACT

A protected test strip holder according to the present invention includes a test strip holder onto which a test strip, such as for example an Almen strip, may be mounted using fasteners provided on the test strip holder. A protective covering is form-fitted to the test strip holder and, optionally, to the test strip holder having a test strip mounted thereon. The present invention also comprises a method for protecting and storing a test strip holder that includes providing a test strip holder, forming or molding a protective covering form-fitting to the test strip holder, and placing the protective covering over the test strip holder. The test strip holder may have a test strip mounted thereon prior to molding the form-fitting protective covering.

### CROSS REFERENCE TO RELATED APPLICATION

This application claims the benefit of U.S. Provisional Patent Application Ser. No. 61/462,461, filed Feb. 3, 2011, which is incorporated herein by reference, in its entirety.

### FIELD OF THE INVENTION

The present invention comprises an apparatus and a method for protecting a measuring device for a metal-finishing process. In particular, the present invention relates to an apparatus and a method for protecting the device for measuring shot peening intensity, namely, the holder or block upon which is mounted an Almen strip. Use of the Almen strip for measuring shot peening intensity is well known in the art; however, what is lacking is an efficient and effective apparatus and method for protecting the Almen Block when not currently in use.

### BACKGROUND OF THE INVENTION

In brief, shot peening is a cold metal-working process that produces a compressive residual stress layer in the subject metal component and concurrently modifies the mechanical properties of that metal component. Shot peening comprises impacting the surface of the subject metal component with round metallic, glass, or ceramic particles, commonly referred to as shot. The force at which the shot strikes the subject metal component, and correspondingly produces a compressive residual stress layer in the subject metal component, is application-specific.

It is well known in the art that the process of shot peening increases fatigue strength in the subject metal component thereby relieving tensile stresses that contribute to stress-corrosion cracking. A detailed description of this process and the materials used therein is found in the ASM Committee “Metals Handbook,” Volume 2, 8th Division, 1964, pages 398-405, and incorporated herein by reference. Prior art shot peening processes are also described in numerous U.S. patents, e.g., U.S. Pat. No. 2,542,955; No. 2,982,007; and No. 3,638,464.

In conventional shot peening processes, spheroid particles of cast steel, cast iron, glass, etc., are blown or mechanically impelled in a high velocity stream against the surface to be treated. The individual shot particles produce shallow, rounded overlapping dimples in the surface, stretching it radially from each point of impact and causing cold working and plastic flow. The resultant compressive stress tends to counteract tensile stresses imparted to the substrate by the preceding rolling, bending, abrading, and similar processes.

As is well known in the art, and as is set forth in U.S. Pat. No. 3,638,464 and No. 6,568,239; two critical shot peening factors are “peening intensity” and “coverage”. Peening intensity is a function of the weight, size, hardness and velocity of the peening particles, exposure time, type of substrate, angle of impingement, and various other factors. Coverage rate or the rate of approach to saturation depends on dimple size, the rate of dimple accumulation and statistics.

Peening intensity is a function of the kinetic energy of the shot impacted upon the surface of the component. It is a function of shot velocity and size. Shot is accelerated by using air pressure to force it through a peening nozzle directed at the component surface. The Almen strip process is well known for measuring shot peening intensity and has been referred to as “the key element in shot peening process control”. (See U.S. Pat. No. 5,731,509).

Developed and patented by John O. Almen, Almen strips comprise thin metal strips that deflect when subjected to shot peening. An Almen strip, often referred to in the art as “test strip”, is mounted in a special holder or block wherein a critical section of the strip is unsupported. Thus, the Almen strip mounted in the special holder or block is exposed to the shot stream under substantially the same condition as the subject metal component undergoing peening.

Almen strips deflect in response to the surface compression produced by shot impacts. One impact will cause some deflection of the strip toward the side struck. As the impacts accumulate, the deflection increases. Deflection is also greater if the impacts are more energetic, for example comprising higher shot velocity and diameter. The Almen strip is a convenient way of assessing the overall peening process.

An almen strip is clamped in a special fixture, namely, an Almen Block, and peened under a given set of conditions, such as, gun air pressure, shot size and shot mass flow rate. The deflections of many strips peened under these conditions and for varying amounts of time are then plotted on what is called a saturation curve. Saturation is said to occur when doubling the peening time has less than a 10% effect on deflection. For practical purposes, at saturation the strip is fully covered with impact dimples so its deflection is proportional only to the peening intensity. Generally, peening of the subject component parts may begin at this saturation intensity.

Almen strips are classified into 3 types: “A”, “N” and “C”. They differ in thickness and define the same width and length. Typical Almen strips are made from SAE 1070 cold rolled spring steel and have surface dimensions of 0.75″×3.00″. Almen strips are commercially available in three thicknesses: 0.031″ (“N”-strips); 0.051″ (“A”-strips); and 0.093″ (“C”-strips). Typically, the “A” strip is selected because its deflection roughly equals the depth of the surface compressive layer in the 0.004 to 0.010″ range. Consequently, a saturated strip which deflects 0.006″ would have about a 0.006″ thick compressive layer on the peened surface. (See U.S. Pat. No. 5,731,509; and No. 6,568,239).

### SUMMARY OF THE INVENTION

Engineers and designers of a numerous metal components require that a particular component function under precise operating parameters. Such operating parameters often require that the particular component exhibit inherent characteristics. Often, the particular component must be subjected to various metal finishing processes to incorporate those necessary characteristics. One such process is shot peening.

The present invention comprises an apparatus for protecting an Almen strip mounting holder, namely, an Almen Block. The present invention also provides an efficient and effective method for protecting the mounted Almen strips. Moreover, the present invention relates to an apparatus and a method for protecting the Almen Block. For the following discussion, the term Almen Block includes the test strip mounting holder and, optionally, with an Almen strip mounted thereon. A more detailed description is set forth in the attached figures as succinctly described below.

A protected test strip holder according to the present invention includes a test strip holder onto which a test strip, such as for example an Almen strip, may be mounted using fasteners provided on the test strip holder. A protective covering is form-fitted to the test strip holder and, optionally, to the test strip holder having a test strip mounted thereon. The present invention also comprises a method for protecting and storing a test strip holder that includes providing a test strip holder, forming or molding a protective covering form-fitting to the test strip holder, and placing the protective covering over the test strip holder. The test strip holder may have a test strip mounted thereon prior to molding the form-fitting protective covering.

### BRIEF DESCRIPTION OF THE DRAWINGS

FIG. 1 provides an isometric view of an Almen Block and a protective cover in accordance with the present invention.

FIG. 2 provides a depiction of an Almen Block in accordance with the present invention.

FIG. 3 provides a depiction of the Almen Block of FIG. 2 having a protective covering form-fitted thereon.

### DETAILED DESCRIPTION OF THE PREFERRED EMBODIMENTS

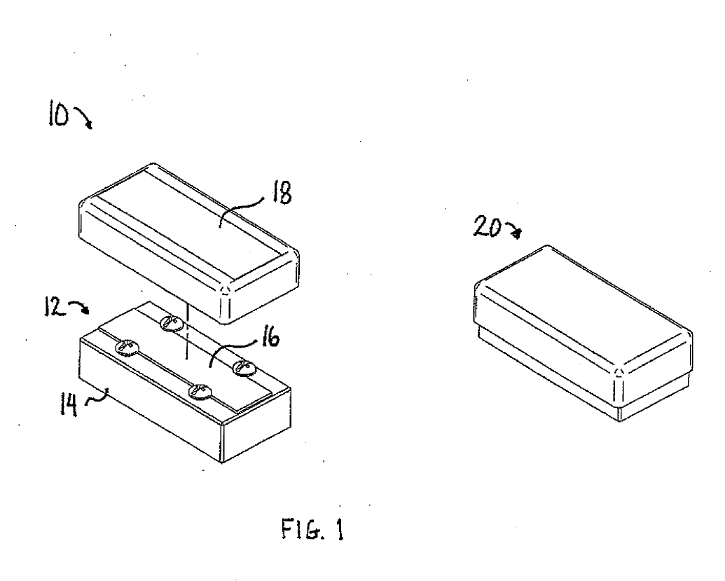

A schematic illustration of an Almen Block and a protective cover in accordance with the present invention is shown in FIG. 1, and is generally designated by the reference number 10. An Almen Block, generally designated by the reference number 12, includes a test strip holder 14 and a test strip 16, an Almen strip, mounted thereon. A protective covering 18, for example a coating, shell, or the like, is form-fitted to the Almen Block 12. Such a protective covering and the like is referred to herein as an “Almen Block Boot”. The Almen Block Boot may be comprised of plastic, vinyl, rubber, or any other suitably malleable material. The Almen Block 12 together with the protective covering 18 is shown as a protected Almen Block assembly 20.

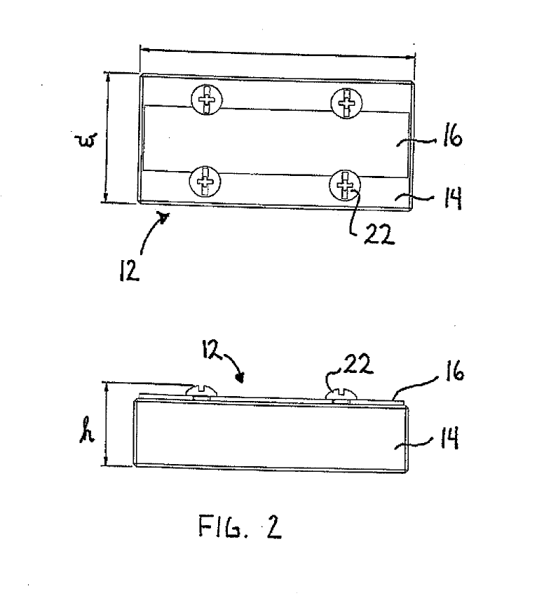

As shown in FIG. 2, Almen Block 12 includes a test strip 16 that is removeably mounted on test strip holder 14 using one or more conventional fasteners 22 such as, for example, machine screws. While machine screws are shown and described, the present invention is not limited in this regard as other types of fasteners suitable for retaining a test strip on a test strip holder may be substituted without departing from the broader aspects of the present invention.

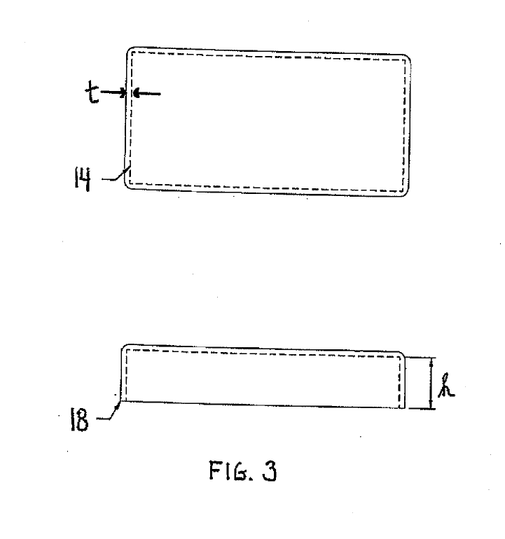

As further shown in FIG. 2 and FIG. 3, test strip holder 14 together with test strip 16 mounted thereon with fasteners 22 defines a height “h”, a width “w”, and a length “l”. Protective covering 18 defines a wall thickness “t” such that the periphery of test strip holder 14 defined by height “h”, a width “w”, and length “l” is covered.

Although the invention has been described with reference to particular embodiments thereof, it will be understood by one of ordinary skill in the art, upon a reading and understanding of the foregoing disclosure, that numerous variations and alterations to the disclosed embodiments will fall within the spirit and scope of this invention and of the appended claims.

What is claimed is:

1. A protected test strip holder comprising:
a) a test strip holder; and
b) a protective covering form-fitted to the test strip holder.

2. A protected test strip holder as defined by claim 1 wherein the test strip holder includes at least one fastener for mounting a test strip on the test strip holder.

3. A protected test strip holder as defined by claim 2 wherein an Almen strip is mounted on the test strip holder.

4. A protected test strip holder as defined by claim 1 wherein the protective covering is plastic.

5. A protected test strip holder as defined by claim 3 wherein the protective covering is plastic.

6. A method for protecting and storing a test strip holder comprising:
a) providing a test strip holder;
b) forming a protective covering form-fitting to the test strip holder; and
c) placing the protective covering over the test strip holder.

7. A method for protecting and storing a test strip holder as defined by claim 6 wherein providing a test strip holder further comprises mounting a test strip onto the test strip holder.

8. A method for protecting and storing a test strip holder as defined by claim 6 wherein forming a protective covering form-fitting to the test strip holder comprises molding the protective covering to be form-fitting to the test strip holder.

9. A method for protecting and storing a test strip holder as defined by claim 7 wherein forming a protective covering form-fitting to the test strip holder comprises molding the protective covering to be form-fitting to the test strip holder with the test strip mounted onto the test strip holder.
